(19) United States
(12) Patent Application Publication
(10) Pub. No.: US 2004/0149063 A1
(43) Pub. Date: Aug. 5, 2004

(54) Tumbler gear and a method for its manufacture

(76) Inventor: Helmut Kanzler, Voehringen (DE)

Correspondence Address: FLYNN THIEL BOUTELL & TANIS, P.C., 2026 RAMBLING ROAD, KALAMAZOO, MI, 49008-1699, US

(21) Appl. No.: 10/704,328

(22) Filed: Nov. 7, 2003

(30) Foreign Application Priority Data
Nov. 12, 2002 (DE) 102 53 875.1

(51) Int. Cl. F16H 55/17

(52) U.S. Cl. 74/460

(57) ABSTRACT

A tumbler gear having radial serrations on which, during the operation of the chain running gear, roll guide elements of a chain. The radial serrations are made at least in sections of a noise-dampening material. The radial serrations are an integral form of an elastomer form body into which is integrated a support-ring structure made of an inherently stable metallic material with an annular tooth-system structure, the pitch of which corresponds with the pitch of the radial serrations.

### FIELD OF THE INVENTION

The invention relates to a tumbler gear for a chain running gear of a tracked vehicle, comprising radial serrations made of a noise-dampening material, on which radial serrations, during the operation of the chain running gear, roll guide elements of a chain, and which radial serrations are reinforced on the inside by a support-ring structure made of an inherently stable material with an annular tooth-system structure, the pitch of which corresponds to a pitch of the radial serrations, and a method for the manufacture of such a tumbler gear.

### BACKGROUND OF THE INVENTION

Such a tumbler gear is generally known from the Applicant through a tracked vehicle in the form of a snow-run grooming vehicle with the trademark “PISTEN-BULLY”. Such a tumbler gear is designed as a plastic gear. The plastic gear has a metallic hub-ring area, which has a support-ring structure provided with a tooth-system structure. The support-ring structure supports from inside the annular radial serrations, which consist of plastic, namely polyurethane. The metallic hub-ring area with the support-ring structure is designed as an aluminum casting. The radial-serrations ring made of plastic has noise-dampening characteristics. The radial serrations made of plastic are subjected to significant wear, whereby in particular the teeth of the radial serrations can be damaged. The pitch of the radial serrations can change due to damaged teeth. This influences the function of the chain running gear.

The purpose of the invention is to provide a tumbler gear of the above-mentioned type, which enables a silent and functionally secure chain run.

The purpose of the invention is also to provide a method for the manufacture of a tumbler gear of the above-mentioned type, which can be carried out simply, functionally secure and inexpensively.

### SUMMARY OF THE INVENTION

The purpose is attained for the tumbler gear by the radial serrations being formed by an elastomer form body. A certain elastic flexibility is achieved for the radial serrations with the solution of the invention. On the one hand, a noise dampening during the rolling of the guide elements of a suitable chain thereon and, on the other hand, a secure, clearance-free guiding of the chain are achieved with this flexibility. Particularly advantageous is the use of a rubber mixture as the elastomer. The support-ring structure with the tooth-system structure in addition guarantees in combination with the elastomer material that each tooth of the radial serrations is supported sufficiently from the inside so that teeth of the radial serrations cannot break off. Thus, the tumbler gear has sufficiently good emergency running characteristics even in the case the elastomer material is partially removed due to wear or damage. The tooth-system structure and in particular the entire support-ring structure are preferably embedded or placed into a mold tool, into which the elastomer is introduced by casting, in the case of a rubber mixture in particular by vulcanization, and is formed into the radial-serrations ring. The elastomer encloses during its manufacture automatically the tooth-system structure and the support-ring structure so that an intimate connection between the support-ring structure and the elastomer radial-serrations ring is created. The elastomer material, in particular the rubber mixture, has caoutchouc-like, elastic characteristics in a wide temperature range, in particular between +50° C. to −50° C.

The elastomer form body is in a development of the invention manufactured out of a rubber mixture, which is wear-resistant, temperature-resistant at low temperatures and is stable. This is a particularly advantageous development since the high elasticity and the great resistance to wear of rubber are utilized. An elasticity even at extremely low temperatures, in particular between −10° C. to −50° C., is maintained in particular by the suitable rubber mixture, which elasticity enables the use of the chain running gear in snow-run grooming vehicles.

The tooth-system structure is in a further development of the invention coaligned in a radial plane with the tumbler gear and coaxial with an axis of rotation of the tumbler gear, and reinforcing webs extend axially at the level of the tips of the teeth and are associated with the tooth-system structure, which reinforcing webs are held on a support ring arranged coaxially with respect to the tooth-system structure. With this a sufficient support is achieved over the entire depth of each tooth. The support-ring structure forms a support skeleton, which reinforces the elastomer radial serrations and guarantees the corresponding emergency running characteristics.

The tooth-system structure is in a further development of the invention provided on the axial outside of an annular disk, which is provided on the axial inside with fastening means for facilitating connection of the tumbler gear to a driving hub on the side of the vehicle. The annular disk includes thus on the one side a tooth-system structure and on the other side a fastening means, with which can be achieved a tying of the tumbler gear on the side of the vehicle or on the side of the chain running gear.

A fastening ring designed in one piece with the tooth-system structure is in a further development of the invention provided as fastening means, which fastening ring has fastener receiving means, in particular holes adjusted to tapholes of the driving hub. A simple screw fastening of the tumbler gear on the vehicle-side driving hub is in this manner achieved so that a simple exchange of the tumbler gear is guaranteed.

The fastening ring is in a further development of the invention embedded in the radial-serrations ring made of an elastomer, and the radial-serrations ring has openings at the level of the fastener receiving means. Thus, the fastening ring is also enclosed by the elastomer material. The openings, which already exist in the form, guarantee nevertheless a secure securement ability of the tumbler gear to the driving hub.

The support-ring structure is in a further development of the invention designed as in situ connected construction system, in particular as a welded construction. This is a particularly easily manufacturable and stable and functionally secure design.

The basic purpose of the invention is attained for the method in such a manner that the support-ring structure is placed or embedded in a mold for the manufacture of the elastomer form body, and that subsequently liquid elastomer material is introduced into the mold, which material encloses the support-ring structure. The creation of the elastomer form body and at the same time the form-locking integration of the support-ring structure into the elastomer form body is achieved in this manner in one operation. In particular a rubber mixture is formed around the support-ring structure by a vulcanization process.

### BRIEF DESCRIPTION OF THE DRAWINGS

Further advantages and characteristics of the invention result from the claims and from the following description of a preferred exemplary embodiment of the invention, which is illustrated in the drawings, in which:

FIG. 1 is a rear view of an elastomer form body of an embodiment of the inventive tumbler gear,

FIG. 2 is a side view of the elastomer form body according to FIG. 1,

FIG. 3 is a front view of the tumbler gear with the inside being illustrated by broken lines,

FIG. 4 is a cross-sectional view of the tumbler gear according to FIG. 3 taken along the cross-sectional line IV-IV of FIG. 3,

FIG. 5 is a support-ring structure integrated into the tumbler gear, and

FIG. 6 is a cross-sectional illustration of the support-ring structure according to FIG. 5 taken along the cross-sectional line VI-VI of FIG. 5.

### DETAILED DESCRIPTION

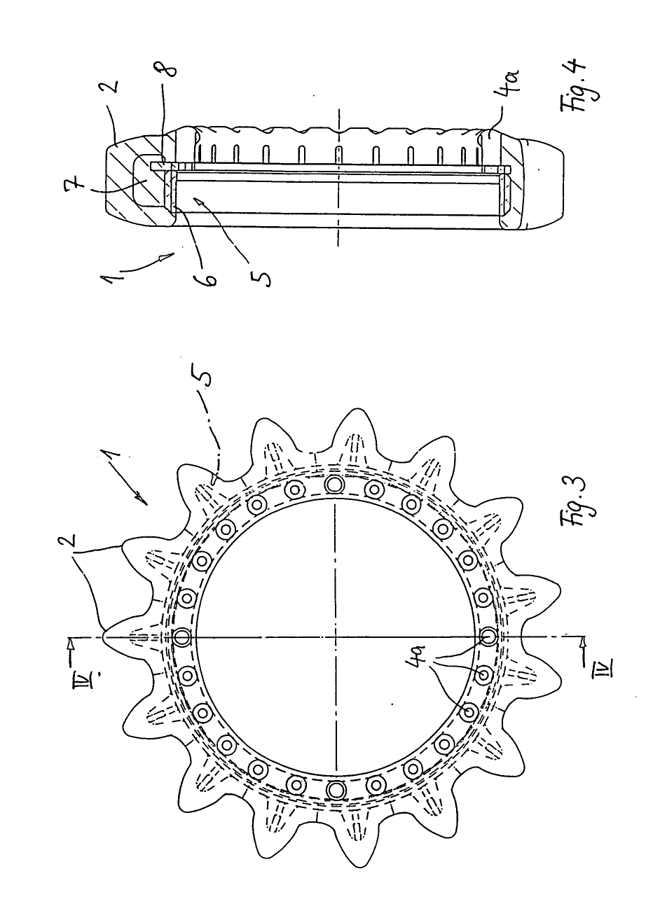

A tumbler gear, as is illustrated in FIGS. 1 to 6 and as will be discussed in greater detail hereinafter, is utilized for a chain running gear of a tracked vehicle in the form of a ski-run grooming vehicle, which is used preferably in the winter for the preparation of ski or snowboard terrain. Such a tumbler gear 1 is principally in a conventional manner fastened on a front end or rear end area of the chain running gear on a driving hub of the tracked vehicle, which driving hub is part of a drive system of the tracked vehicle. One chain running gear is provided on each side of the vehicle, whereby both chain running gears each have one tumbler gear.

The tumbler gear 1, according to FIGS. 1 to 6, has radially extending serrations or gear teeth 2 made of an elastomer material, preferably a rubber mixture, whereby the radial serrations 2 are designed as an annular elastomer form body 1a. A support-ring structure 5 is form-lockingly integrated into the elastomer form body 1a, which support-ring structure 5 reinforces the inside of the radial serrations and thus the elastomer form body 1a. The elastomer form body 1a, which forms the radial serrations 2, is manufactured in a mold tool, which is in the case of a rubber mixture constructed as a vulcanizing mold. The liquid elastomer material is moved into the mold. In order to achieve a form-locking connection with the support-ring structure 5 oriented on the inside thereof, the support-ring structure 5 is embedded into the mold tool prior to the introduction of the liquid elastomer material. The positioning within the mold tool corresponds to the later position of the support-ring structure 5 in the elastomer form body 1a. After the introduction of the liquid elastomer material into the mold and after the hardening or curing of the elastomer form body has occurred, the elastomer material form-lockingly encloses the support-ring structure 5 so that the support-ring structure 5 and the elastomer form body result in a common unit, which represents the inventive tumbler gear 1.

The elastomer form body, which forms the radial serrations, has a plurality of radially outwardly projecting teeth 2, which are designed in the form of an involute-tooth system. Concavely arched roots 3 lie between the individual teeth. The elastomer material, preferably the suitable rubber mixture, is selected corresponding to the metallic guide elements of the respective chain of the chain running gear so that the elastomer material is a suited friction partner for the metallic material of the guide elements of the respective chain. The elastomer material is chosen in such a manner that it has a good damping and a smooth running characteristic, a sufficient weather resistance characteristic, in particular for winter and snow operation, and a high wear resistance characteristic.

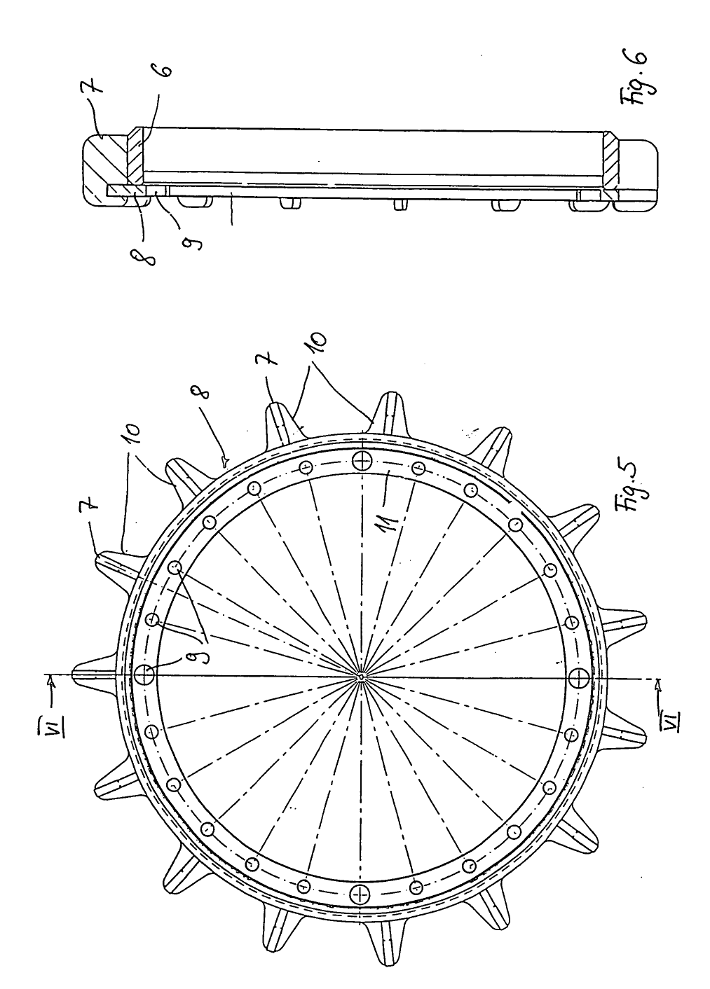

In order to support the individual teeth of the radial serrations, namely of the elastomer form body, radially from the inside, the support-ring structure 5 has a tooth-system structure 10, which is formed by radially protruding teeth. The teeth project analogous to the teeth of the radial serrations radially outwardly and have a pitch which corresponds with the pitch of the radial serrations of the elastomer form body. The tooth-system structure is part of an annular disk 8, which is coaligned in a radial plane with the tumbler gear and coaxial with an axis of rotation of the tumbler gear 1. A coaxially arranged support ring 6, which projects axially to one side from the annular disk 8, is fixedly connected to the annular disk 8, preferably via welding. The teeth of the tooth-system structure 10 are in addition reinforced by reinforcing webs 7 which extend coextensively over a portion of the depth of the teeth of the radial serrations 2, and are plate-like and extend both axially and also radially outwardly. Radially outwardly open slots are provided in the tip of each tooth of the tooth-system structure 10 for fixedly receiving therein a respective reinforcing web 7. Each reinforcing web 7 is welded to both the tooth-system structure 10, namely to the annular disk 8, and also to the support ring 6. Thus, a welded construction made of a metallic material, in the present case made of an aluminum alloy, results and which can be clearly recognized in FIGS. 5 and 6. The reinforcing webs and the teeth of the annular disk 8, which together form the tooth-system skeleton for the elastomer form body, are designed in such a manner that they guarantee, even if one or several teeth of the elastomer form body are torn off, a still safe and secure tooth engagement of chain and tumbler gear and thus provides a good emergency running characteristic.

In order to be able to fasten the tumbler gear 1 onto the respective driving hub, the annular disk 8 has on the inside an annular flange 11 serving as a fastening ring, which annular flange 11 projects radially inwardly and has mounting holes 9 therethrough. As can be recognized looking at FIGS. 1 to 4, the elastomer form body has an inner ring covering the annular flange and at the level of the mounting holes 9 corresponding openings 4a so that suitable mounting screws, which fasten the tumbler gear 1 onto the driving hub, can be moved through these openings 4a and through the mounting holes 9.

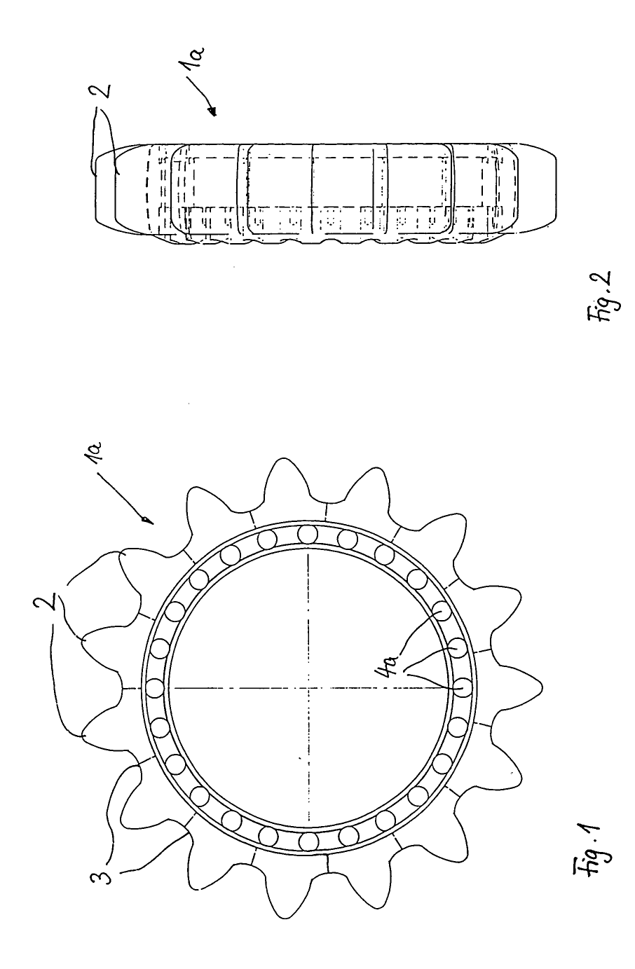

FIGS. 1 and 2 illustrate the elastomer form body 1a with the radial serrations 2 and the openings 4a, whereby for a better overview the illustration does not show here the integrated support-ring structure 5. Since FIG. 1 illustrates the rear side of the elastomer form body 1a, it can be easily recognized that the elastomer form body also has an inner ring, which is positioned axially in front of the annular flange 11 of the support-ring structure 5, which annular flange 11 serves as the fastening ring. This inner ring covers thus the annular flange 11 forwardly. At the same time it guarantees together with the provided openings 4a that the corresponding fastening screws fix both the elastomer form body and also the support-ring structure to the driving hub.

What is claimed is:

1. A tumbler gear for a chain running gear of a tracked vehicle, comprising radial serrations made of a noise-dampening material, on which radial serrations, during the operation of the chain running gear, roll guide elements of a chain, and which radial serrations are reinforced on the inside by a support-ring structure made of an inherently stable material with an annular tooth-system structure, the pitch of which corresponds to a pitch of the radial serrations, wherein the radial serrations are in a form of an elastomer form body.

2. The tumbler gear according to claim 1, wherein the elastomer form body is manufactured out of a rubber mixture, which is designed non-abrasive, temperature-resistant and wear-resistant and stable.

3. The tumbler gear according to claim 1, wherein the tooth-system structure is coaligned in a radial plane with the tumbler gear and coaxial with an axis of rotation of the tumbler gear, and wherein reinforcing webs extend axially at the level of the tips of the teeth and are associated with the tooth-system structure, which reinforcing webs are held on a support ring arranged coaxially with respect to the tooth-system structure.

4. The tumbler gear according to claim 3, wherein the tooth-system structure is provided on the outside on an annular disk and has on the inside fastening means for facilitating connection of the tumbler gear to a driving hub on the side of the vehicle.

5. The tumbler gear according to claim 4, wherein a fastening ring designed in one piece with the tooth-system structure is provided as the fastening means, which fastening ring has fastener receiving means, in particular mounting holes configured to align with tapholes of the driving hub.

6. The tumbler gear according to claim 5, wherein the elastomer form body has an inner flange which covers the fastening ring of the support-ring structure, and which has openings at the level of the fastener receiving means.

7. The tumbler gear according to claim 1, wherein the radial serrations of the elastomer form body are in the form of an involute tooth system.

8. The tumbler gear according to claim 1, wherein the support-ring structure is designed as in situ connected construction system, in particular as a welded construction.

9. A method for the manufacture of a tumbler gear according to claim 1, wherein the support-ring structure is embedded into a mold for the manufacture of the elastomer form body, and wherein subsequently liquid elastomer material is introduced into the mold, which material encloses the support-ring structure.

10. The method according to claim 9, wherein a rubber mixture is used as the elastomer, which rubber mixture is formed around the support-ring structure by vulcanization.
